(19) United States
(12) Patent Application Publication
(10) Pub. No.: US 2004/0243746 A1
(43) Pub. Date: Dec. 2, 2004

(54) Character generation system

(76) Inventor: Constant T S Wong, Melbourne (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/470,327

(22) PCT Filed: Jan. 25, 2002
(86) PCT No.: PCT/AU02/00077

(30) Foreign Application Priority Data
Jan. 25, 2001 (AU) PR 2702

(51) Int. Cl. G06F 13/12

(52) U.S. Cl. 710/72

(57) ABSTRACT

A character generation system which generates unique characters by actuation of key stroke combinations has a plurality of input keys each of which is associated with at least one part character unit, and characters are generated by key input signals which generate a stroke, radical or character unique to the particular key, the key and key combinations producing a character, or a combination of strokes or radicals which can be further combined with others to produce the desired character.

### BACKGROUND OF THE INVENTION

This invention relates to a character generation system and relates particularly to a system for generating characters, such as language characters using an input device such as a plurality of input keys on a keyboard or the like.

Chinese characters are generally made up of strokes and radicals. Strokes are essentially single components whereas radicals are effectively sub-entities or characters. The latter embody specific meaning and are primarily used for dictionary search, because Chinese characters are classified according to their dominant radicals and their number of strokes.

Of course, a simple character may just have one or more simple strokes and more complex characters can be a single radical, or they could be a combination of radicals and strokes.

The conventional Chinese manual typewrite has a bank of character dice. It is a bulky and heavy device and therefore not readily portable. When a particular character is selected, the character die is removed from the bank, struck onto the paper and then returned to the bank.

This is an extremely complex and difficult operation requiring a high level and range of mental and physical skills. Many thousands of character dice need to be stored in the bank if a modest and satisfactory vocabulary were to be incorporated. The operator of such a typewriter has to be extremely skilled to search and locate, and then manipulate the device to achieve a result within a meaningful time frame. The utilisation of such a manual typewriter is by and large restrictive and useful only for commercial and publishing enterprises.

Since computerisation, many forms of Chinese language computer related typing or input devices, methods or systems have been proposed or come into existence. Such device, methods or systems are fundamentally based on the standard electronic “alphanumeric keyboard” (Qwerty keyboard) and, in one form, use a combination of keys to activate an electronic search. Such a search may normally bring up a number of possible characters with similar homophonic or graphic properties, and from which the operator may select the one required.

Electronically, Chinese characters are fundamentally linked to two particular “Character Sets” or “Character Codes” respectively. These sets or codes are often referred to as “Internal Codes”. “Traditional” characters are linked to the B-5 Set. Whereas “Simplified” characters are linked to the GuoBiao, commonly referred to as the GB.

The Big-5 character set originated in Taiwan and is made up of 13,050 “Traditional” characters. The characters are arranged traditonally, that is, according to the order of strokes and radicals. Each character is given a four letter-numeral reference in descending order. These references are often referred to as the Internal Codes of the “Character Set”.

On the other hand, the GB character set came from the People's Republic of China and has about 7,000 “Simplified” characters, where common words are arranged in a phonetic order, and rare words are arranged according to radical groups. It has a similar four letter-numeral internal code. While important for technical and programming applications, these codes are seldom, if ever, seriously considered as a practical basis for user input methods.

Based on similar schematic structures, the “Traditional” Big-5 and the “Simplified” GB share many common schematic properties. But unfortunately, these common properties refer to very different objects, thus making it logically impossible for the two “Character Sets” to actively share the same environment at any given time. In other words, access to both sets at any given time is denied. They are logically incompatible.

Moreover, in the process of character simplification and vocabulary reduction, any “Traditional” characters were retained. In the interest of reduction in the size of the vocabulary and the simplification of form and structure, many “Simplified” characters were contrived to individually replace two or more different “Traditional” characters. For conversion purposes, this has resulted in the inherent difficulties of matching one “Character Set” with the other. Thus while it is possible to convert from “Traditional” to “Simplified” on a many-to-one basis, it is logically impossible to do so, without human intervention, from “Simplified” to “Traditional”. To put this in another way and where the two “Character Sets” are involved, it may be possible to contrive a means by which “Traditional” texts can be automatically converted into “Simplified” forms. But when it comes to reversing the process, human intervention is necessary.

As stated, the two “Character Sets” are mutually incompatible. Popular opinion is that a better, more inclusive and very different coding system is needed. One such code known as Unicode has been created. Its inclusiveness extends across languages including English, Chinese, Japanese and Koran. Although its current version has problems and lacks widespread acceptance, it is nevertheless a very promising development

The present invention has been developed in part in an endeavour to adapt a keyboard input device to any existing Internal Code, including Unicode or its successors, as well as any graphic based language.

The “Traditional” characters have been used universally until the emergence of the People's Republic of China (PRC). Since then they remain as the standard outside the PRC. As for the PRC, the “Simplified” characters, developed concurrently with her Pinyin spelling method, became the norm for Mainland China. As a whole, the two are significantly different from one another. Users of the two forms have much difficulty in understanding and writing each other's version. Furthermore, as romanisation of Chinese gained popularity over the Mandarin Phonetic symbol, spelling systems developed along separate lines, in and outside Chinese circles, leaving behind the current legacy of diversity. For “Traditional” characters, most popular dictionaries tend to follow the Thomas Wade and the Guoyeu Romatzyh spelling systems. For “Simplified” characters, the PRC has her Pinyin instead.

### DESCRIPTION OF THE PRIOR ART

Previously proposed devices and systems fall into two broad input categories, namely the “construction” and the “spelling” categories.

The input process of the “construction” approach involves constructing graphic characters from building components of strokes and radicals, the latter being more than 220 in number. Systems have been developed to reduce the multitude of components that make up Chinese characters to manageable number so that the essential number may be represented by the keys of the Qwerty keyboard. The alphanumeric keys that identify the various proposed building components of characters, and the precise sequence that these keys must follow in the input process is commonly referred to as the External Code of the characters in question. It will now be clear to the reader that the External Code is inseparably linked to the Internal Code of the “Character Set” (Big-5 or GB).

All “construction” input methods develop their own unique External Code. Naturally, they differ from one another in their choice and number of building components, the alphanumeric representations thereof, and the strict order by which the building components are to be strung together.

The key arrangement and keyboard operation vary from one device, method or system to another. In the simplest form, each stroke, or stroke-form is essentially given a number or a letter of the alphabet, and depending upon the form of device, method or system, these could be from four to six different letters of the Roman alphabets. These numbers or letters, or the combination of the two are then keyed in sequentially. Normally they are based on the order in which a particular character would be written, until the keystrokes are completed or would lead to what is seen as an unambiguous characters, or characters showing some dominant common features.

These forms of operation need a highly skilled operator with the following basic requirements:

(a) knowledge and efficiency in the use of the “alphanumeric keyboard”;

(b) a good knowledge and ability to use a given code;

(c) familiarity with a set of given rules which are often complex, rigid and inconsistent.

In the final stage of the process the operator often needs to make a selection of the particular character in mind from a number of presented characters.

“Construction” systems and devices enjoy limited currency, success or lasting appeal. As noted above, the reasons for their short shelf life and poor appeal are obvious. With few exceptions, they require a fairly high level of Chinese literacy to carry out word analysis. They also require knowledge and skills to follow a rigid order of correct keystrokes. The user is faced with a complex, rigid and dauntng barrage of rules and definitions. More often than not, to achieve a desired level, of typing speed, special External Codes need to be committed to memory. Distinctions may need to be made regarding “common” and “rare” words so that they may be treated differently. With few exceptions, if any, there is absolutely only one way to construct any particular character. They fail to provide for marginal errors, users' lack of familiarity with the many and different forms of variant words (current, archaic, corrupted, popular, in-use, out-of-use, printed, or hand-written forms). And for input purposes, they do not accept such variants. When typing mixed Chinese and English texts, users are required to manually and repeatedly switch between the two (Chinese and English) input methods. Often when users reach an input impasse, they have no other choice but to switch over to other input methods in order to carry on, if at all possible. Finally, having done some or all of the above, the users must look for and select the targeted word from word lists presented on the screen.

In brief, current “construction” devices, methods and systems based on the Qwerty keyboard are rigid and user-unfriendly. Prospective users are dissuaded from using them because of the skills and levels of commitment required of them.

Most marketed products are based on the “Spelling” approach. While it is recognised that the Pinyin romanisation has gained ascendancy in this field, it must be borne in mind that there is no universally recognised standard of romanisation. Nor is there likely to be one in the foreseeable future.

Like its western counter-parts, romanised words can be arranged alphabetically and phonetically in descending order. Relatively, they are simple to classify, encode and manipulate. However, unlike Latin based languages Mandarin Chinese in particular is a homophonic language with four specific levels of tonal values. Though completely different in their meaning, usage or form, many Chinese words share common phonetic and tonal values.

Furthermore, the same words may change their context-specific meanings, of resulting in changes of phonetic and tonal values. On the other hand different words may have the same phonetic and tonal values whether they have the same meaning or not. Therefore one may list words which share certain common sequential letters of the alphabet, or all the letters of words. But owning to the commonly shared homophonic and tonal values, it is logically impossible to eliminate the process of selection. The process of indexing may reduce substantial difficulties. For example, it may help narrow word lists, or reduce the tasks of typing out the full words. But whatever their improved capabilities may be, by themselves or in concert, they cannot provide any absolute solution.

Various methods of indexing have given rise to various “intelligent systems” or intelligent features. Indexes are established for frequently used words, used in association with one another, words used in association with terms or phrases, and words used in context with immediately preceding words, and so on. These “intelligent” features are incorporated into many systems or are offered as options to be turned on and off. At their best, these are helpful features only for some of the time. At their worst, they may become woeful distractions, liabilities, or down right nuisance. The truth is no “intelligent” systems or indexing can possibly anticipate absolutely what the user has in mind.

Speakers of Chinese as a second language have found it necessary to use something like Pinyin to get them started. But even at a very early stage, they need to make a quick transition from the romanised to the graphic forms if they are to make any progress at all. Once the transition is made, learning takes place in the traditionally Chinese fashion—constant practice, hand writing exercises and word drills. Once the transition happens, confidence and competency in romanisation is often diminished through disuse and lack of practice.

For native speakers, language acquisitions begin at an early age. Though one may possibly be introduced to romanisation at a later stage of the learning process, it would hardly ever be necessary to think or operate in a romanisation environment, except for computer operations. As in the case of speakers of Chinese as a second language, romanisation inevitably suffer the same fate. Thus it is not surprising that most Chinese speakers do not know or have the confidence and competence in romanisation to be enthusiastically interested in using “spelling” products.

One of the serious difficulties with all the existing “spelling” devices, methods or systems is that it is an imported “foreign” phonetic system. There is no universally accepted standard of spelling and it is unlikely that such a standard will be adopted in the foreseeable future.

Another difficulty relates to the complexity of the Chinese language. It is common that users who possess a high level of Chinese literacy may not know the pronunciation, much less the correct pronunciation of a great many words, even though they may know their meaning and use absolutely. There are also many instances when they may not know the numerous variant forms of the same words. As we have noted earlier, such variant forms extend over a range of current, archaic, corrupted, popular, in-use, out-of-use, printed and hand-written forms. A search of the dictionary may not necessarily resolve the difficulty because of the differing spelling systems and such systems are based either on a foreign language alphabet (English) or the Mandarin Phonetic alphabet. With reference to the latter, comparatively few are familiar with it.

The fundamental difficulty with the “spelling” system is that when the user is not able to spell a given word, or spell it correctly according to the spelling system in use, he would find it difficult to proceed. To spell properly, the user needs to know the correct and standard pronunciation of words, distinguish subtle differences in phonetic and accent, deliberate on linguistic, geographical and subjective cultural differences, consult different spelling systems and dictionaries, and so on. Thus, ultimately, if it is not possible to pronounce a word perfectly and correctly, an impasse is reached.

The present invention attempts to address at least some of the fundamental problems mentioned above. The outcome lies not in the incorporation of foreign elements into the system or the acceptance of the Qwerty keyboard as the ultimate tool. Its approach is based on the nature of the Chinese character itself, and, in particular forms, the invention makes the prior art, alphabet-oriented spelling approach redundant.

Speech Recognition and Writing Pad

Great advances are being made in the area of speech recognition and electronic writing pads. However, as practical and efficient input methods, they are still a very long way away from displacing, if ever, the generic need for a keyboard. However, they do have practical and useful applications. Furthermore, almost all the above mentioned problems faced by “spelling systems” apply equally, if not more, to speech recognition.

As discussed herein, it can be seen that proposals hitherto are targeted at specific minority groups. Proposals utilising the “construction” and “spelling” methods have serious limitations and are not easy to use. Without exception, they are totally reliant on the Qwerty keyboard. It is considered that such restrictive dependence is their common, most serious and fundamental shortcoming. The Qwerty keyboard evolved from the specific nature of the English language that is fundamentally and generically different from and far less complex than Chinese. Thus, attempting to fit Chinese into an English model must lead to difficulties.

The mass market would not be better served by a proliferation of more of the same kind, or improved versions of what are already in the market. A solution lies in decisively moving away from a slavish dependence on the Qwerty keyboard.

In our International Patent Application No PCT/AU99/00899 we have described an input device for generating graphical indicia representations, such as language characters, using a plurality of keys which have units associated therewith, the units on adjacent keys being similar to enable easy navigation by an operator around the keyboard. The keyboard described in that patent application has a relatively large number of keys, for example, over a hundred keys, and each key is associated with a unique “unit” whereby characters are able to be generated by actuating no more than, for example, four keys.

In many applications, however, it is useful to provide a keyboard having no more than, for example, ten keys, such as may be found on a telephone or other device employing input keys. It is therefore desirable to provide an improved system which is able to generate predetermined graphical indicia representations, such as language characters, using a keyboard having a relatively small number of input keys, for example ten keys.

It is also desirable to provide a character generation system which is relatively simple to use and which is able to generate any one of a predetermined number of individual characters.

It is also desirable to provide a character generation system whereby each character is generated by predetermined key stokes.

### SUMMARY OF THE INVENTION

According to one aspect of the invention there is provided a character generation system to generate predetermined character representations comprising a plurality of input keys each being associated with at least one unique part character unit, and character generation means receiving key input signals on actuation of a key and adapted to generate a unique character dependent on the combination of actuated keys.

In accordance with a second aspect of the invention there is provided an input device to generate predetermined graphical indicia representations, such as language characters, comprising a plurality of input keys each having associated therewith at least one unique unit, the units comprising recognisable parts of the graphical indicia, and generation means to generate a predetermined representation for any given key, or key combination, actuation.

In one form of the invention, ten keys are used for generation of a predetermined number of unique graphical indicia representations, such as language characters, particular Chinese or Japanese language characters. In a preferred embodiment of the invention, each key is programmed to generate a basic unit such as a simple stroke or combination of strokes, for example, an open box. In addition, each key is associated with two radicals which sometimes, but not necessarily incorporates the basic unit whereby the basic unit or one or other of the radicals is able to be combined with other basic units or radicals of other keys, or the same key, to constant a desired character.

In another preferred form of the invention, the system uses a display or monitor on which the generated character is displayed on completion of the actuation of the desired combination of keys. The display or monitor may also be arranged to display possible combinations, or extensions, of characters which are able to be generated by the actuated key or combination of activated keys at all stages of the character generation. Thus, when a key is struck, an extension window on the display displays a character associated with the actuated key, or key combination together with a list of other possible characters, radicals or basic building blocks which may be generated by actuation of other keys. In one form of the invention, the character extensions may indicate, in a contrasting colour such as red, the key strokes necessary to generate other characters which are part of the character extension. Characters, radicals or building units in shift positions are indicated with another colour, say green or by other means.

In order that the invention will be readily understood, embodiments will now be described with reference to the accompanying drawings wherein:

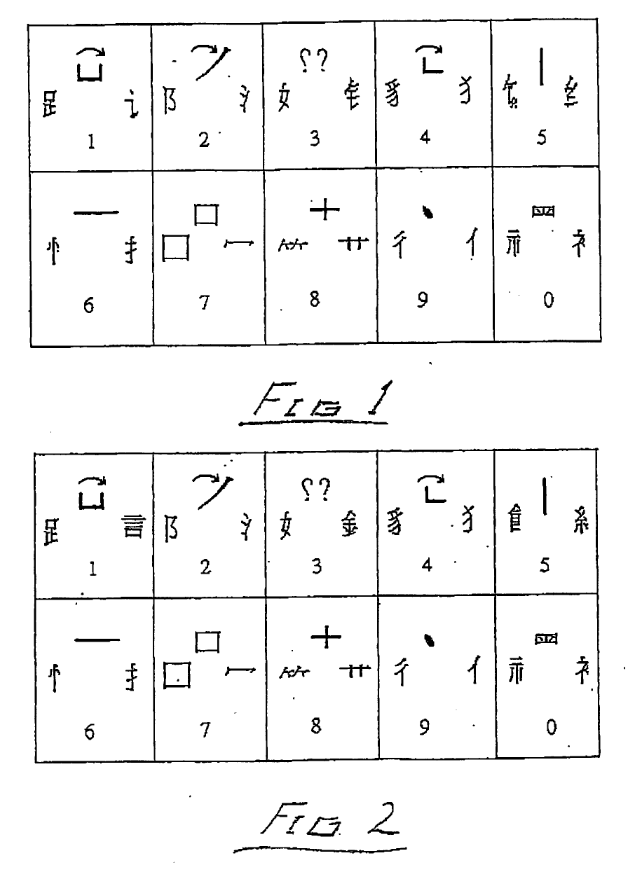

FIG. 1 illustrates the basic units and characters associated with each numerical key for a ten key keyboard for the “Traditional” character set;

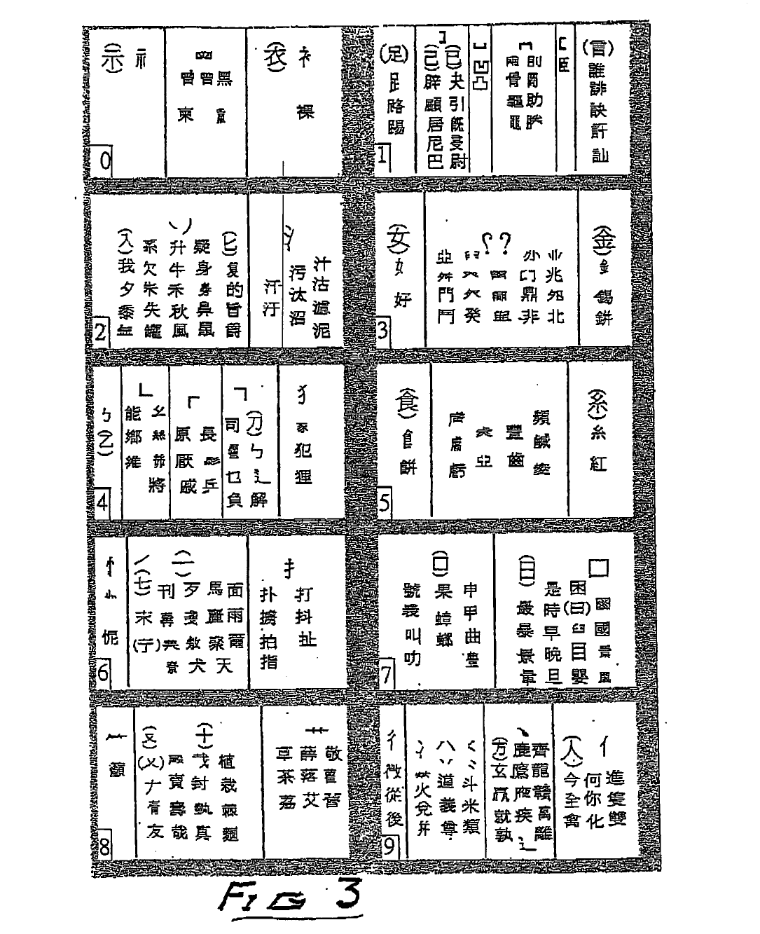

FIG. 2 illustrates the basic units and characters associated with each numerical key for a ten key keyboard for the “Simplified” character set;

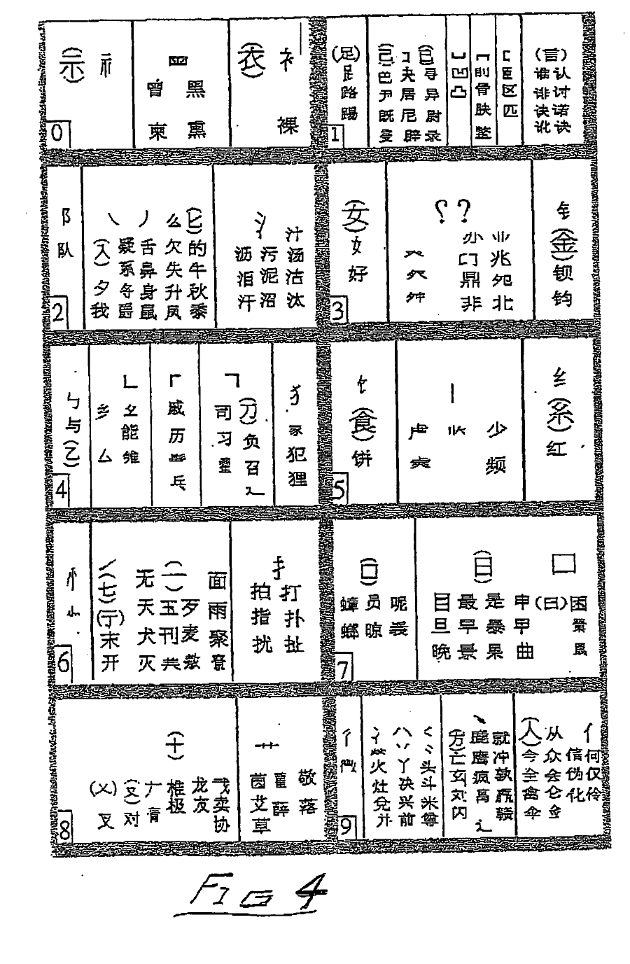

FIG. 3 illustrates the key extension window for each of the numerical keys for the “Traditional” character set;

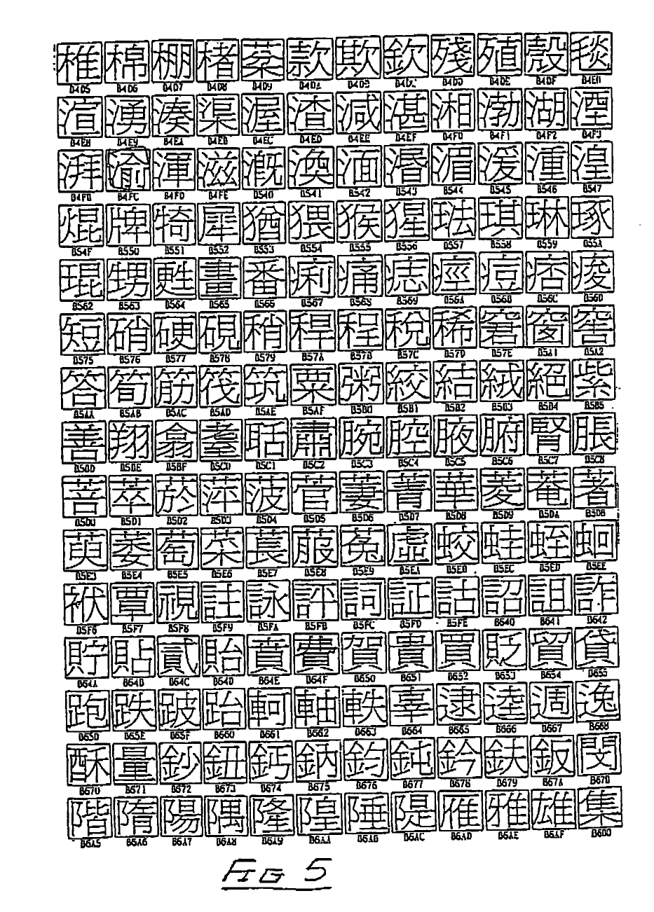

FIG. 4 illustrates the key extension window for each numerical key for the “Simplified” character set;

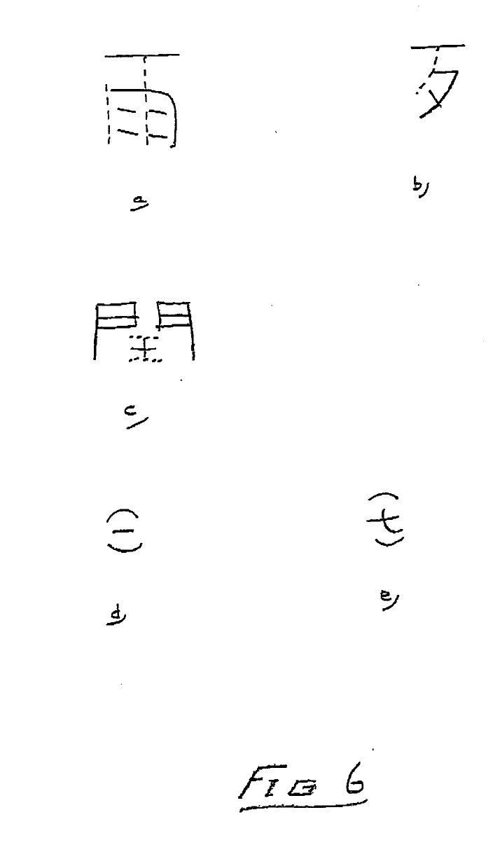

FIG. 5 illustrates some of the many different Chinese characters from the “Traditional” character set which may be generated by the character generation system of the present invention;

FIG. 6 illustrates several individual characters able to be generated by particular combinations of keystrokes.

Referring to the drawings in the preferred embodiment of the present invention, a keyboard is provided with ten input keys which are programmed to generate predetermined basic units as shown in FIGS. 1 and 2. The keyboard may be a stand alone keyboard or be part of some other equipment, such as a normal “qwerty” keyboard, a mobile or other telephone push button device, a calculator or any other suitable input device. The features of the present invention are not limited to the use of physically actuated keys and may extend to, for example, voice recognition input devices or any other input device which is able to be programmed to accept an input from an appropriate source to generate the predetermined graphical indicia representation.

The designs of FIGS. 1 and 2 show the actual order of the arrangement of the ten keys, their corresponding positions on the numeric keys if mapped onto the qwerty keyboard, and the centerpiece of each key. The centerpiece of each key includes a simple basic building unit, together with two common radicals, one in the shifted mode (coloured green) and the other in the normal mode. Each of these three units could be a full character in its own right. On the actuation of a particular key, two full characters can be formed, one in each mode. In the event a full character is not represented by one of the three units shown on the key, it will be displayed in the extension window explained below. The arrows shown on keys 1, 2 and 4 indicate that the particular basic unit is a unit which can be oriented in any direction. The mirror imaged question marks on key 3 designate any mirror image radical. The following table sets out a basic description of each basic unit for the respective keys. The table is applicable to both the “Traditional” and “Simplified” keyboard.

| Key Number | Basic Unit Description |
|---|---|
| 1 | open box |
| 2 | oblique stroke |
| 3 | mirror image radicals |
| 4 | any corner |
| 5 | vertical stroke |
| 6 | horizontal stroke |
| 7 | squares |
| 8 | any cross |
| 9 | dot |
| 0 | spectacles |

The actuation of a key gives rise to the generation of a possible character, radical or basic building unit which incorporates the basic unit of the respective key centerpiece as well as two full characters indicated by vertical brackets, one in the normal and the other in the shifted mode, regardless of whether they have already been included in the centerpiece or not. Thus, actuation of key 6 will give rise to the generation of a radical or character or a building unit which incorporates the horizontal strokes. In the present case, the centerpiece (-) is a full character in its own right. At the same time, when any key is actuated, a key-extension window will be displayed on a monitor or a separate screen on the keyboard itself, depending on the design and application. The key-extension examples of which are illustrated in FIGS. 3 and 4 indicates to all intents and purposes those parts of each key, which for practical and aesthetic reasons are concealed from the key itself. It is advisable that, for the purpose of easy search, the parts on the extension are classified according to the stems from which they are derived, namely that parts on the physical key itself. In fact, in order to narrow the search field further, the stem itself can be subdivided, especially in the case of keys 1 and 4, where open squares and angles respectively in any direction could be subdivided according to the directions they face. On each key or its extension, there are two full characters, one in the normal and the other in the shifted mode. Thus when entry is terminated after the actuation of a first key, one of the two full characters resident therein will be generated, dependent on the mode of the actuation. More likely than not, on each key-extension there are units or radicals or even full characters with one or more strokes in a different colour, say red, which indicates the additional strokes needed to complete that particular unit, radical or character, as the case may be. At all times of the operation, the user should concentrate on the part he has in mind, and totally disregard any other parts sharing the same key or its extension, as all parts belonging to a particular key are absolutely mutually exclusive. Therefore, whether one key, two keys or up to a maximum, for the illustrated embodiments, of eight keys are actuated in sequence, on termination of entry, one and only one character could be generated.

When a second key is actuated, it too will open up to an extension window, replacing that of the first actuated key or displayed alongside it in second position, depending on the design. However, it must be borne in mind the extension of the second actuated key has the same properties and functions of those of the first, nothing more or less, must a display of the hidden parts of the second key, and not the cumulative result of the two keys. When three, four or up to eight keys are actuated, their extensions will do exactly the same as the first two keys. It is preferable that the extensions of all the keys actuated in the process of constructing a certain character are displayed in sequential order alongside one another as a visual reminder of what keys, or what units if you like, have been actuated at any stage of the construction, provided the monitor size of the appliance allows. Alternatively, a mere display of the key numbers or for that matter the key tops will suffice in the event of insufficient space on the monitor.

Referring to FIG. 6, in the preferred embodiments of this invention, when, for example, key 6 is actuated the key extension which opens up the extension window of the 6 key displays, among other characters and radicals, those characters shown in FIGS. 6(a) and (b). The strokes represented with broken lines in FIG. 6 are represented in the extension window in red or another contrasting colour. The missing strokes indicate what key needs to be executed in order to generate the illustrated character. In the case of FIG. 6(a), actuation of FIG. 5 (vertical stroke) will provide the missing vertical strokes needed to complete the character. For the character shown in FIG. 6(b), actuation of key 2 will insert the missing oblique stroke. It is worth mentioning here that building units or blocks can be constructed in the same way of providing missing strokes, and then used for the construction of the targeted character. It is also worth mentioning that characters constructed from drawing (a) and (b) can also be used as building blocks for the construction of more complex characters incorporating them. Drawing FIG. 6(c) shows a character from key 3 (mirror images) with two missing horizontal strokes, which are represented by key 6, as we have already noticed. As a practical case in point, this exemplary incomplete character can be generated in full by the keystroke sequence 366. Drawing FIG. 6(d) shows the complete character (meaning one) in the normal mode, whereas drawing (e) the complete character (meaning seven) in the shift mode on the same key. The vertical brackets seen in these drawings and in FIGS. 3 and 4 are used to point out which are the two complete characters resident in each key. Complete characters, as well as incomplete ones, radicals and units in the shift mode can be distinguished in a different colour, such as green, or some other device, such as frames, boxes, or underlines, etc.

It pays here to point out in passing that the red missing strokes are to be entered in their pre-assigned mode, whether shift or non-shift, regardless of the assigned mode of the character, radials or building blocks they are used to complete. For instance, a shifted block (in green) with a missing vertical straight line (in red) should be completed by actuating key 5 in the normal mode. Conversely, a normal block (in black) missing a vertical line with hooked end (also in red) should be completed by actuating key 5 in the shifted mode, pre-assigned to that stroke on the key or its extension.

FIG. 6 illustrates a few of the thousands of different characters which may be generated by the character generation system of the embodiment of the invention described herein. The particular characters illustrated are an example of a few only of the characters of the “Traditional” character set. It will be appreciated that characters of the “Simplified” character set or of a Japanese character set, or any other character set may be programmed for generation by a system in accordance with the present invention.

It will be appreciated that, with the preferred embodiment of the invention, when a keystroke has been executed, a key extension window will open on a display monitor showing the extensions such as those of FIGS. 3 and 4. The key extensions will display a number of characters, radicals or basic building units which are able to be generated by the particular key. If the sequence of keystrokes is terminated after the first key is actuated, one of twenty characters will be generated depending on which key and which mode was actuated. It will be appreciated that the characters, radicals and basic units associated with each key may be determined as desired for any application of the invention.

It will also be appreciated that, in the embodiments illustrated, a maximum of eight keystrokes may be required to input a character. After the seventh key is actuated, an audible and/or visual warning may be provided to the operator as a reminder that only one further keystroke is available for the construction of the character required. It will be appreciated that the surest way to obtain the correct character is to key in the last stroke, radical or basic building block, as the case may be, of the character in question. However, if the operator overlooks this rule the correct character will be generated 90% of the time in any event.

It will also be understood that the identification and selection of individual characters from a character set having many thousands of different characters is preferably generated by an appropriate computer program which is able to generate any desired character from a predetermined combination of key actuations. In the overwhelming majority of cases, small departs from the standard order of strokes (if there is such a thing) or small discrepancies in stroke selection will not affect the correct return of a character. However, in some instances, it may be necessary to ensure that the key actuation occurs in a particular predetermined order in order to give rise to the desired character. The order of key generation generally follows the usual order of writing the characters stroke by stroke, although this order may be varied as desired in any particular program.

It will be understood that, by identifying basic units of a character set and developing particular radicals incorporating those basic units, it has been possible to provide a character generation system which uniquely generates desired characters with given key stroke combinations. The particular basic units associated with each key actuation may be varied in accordance with the particular application or character to be generated. For example, actuation of key 9 to generate a dot, or full stop, may produce one or two dots as the context requires. Thus, it is not necessary to actuate key 9 twice in order to generate two dots if the desired character can only be constructed with two dots.

While this invention has been described with particular reference to a ten key keyboard, it will be understood that the principles of the invention may be applied to keyboards of any desired number of keys.

When the invention is used in conjunction with the keyboard of a calculator, mobile telephone or the like where the screen is relatively small, the display may be maximised by using a star key to select particular column of the extension window and using the # key to select the first, second, etc characters, radicals or building blocks in the screen. While this may reduce the speed of selection of particular units, radicals or characters, the advantages of being able to build a character using the keystrokes far outweigh the relatively minor reduction in character generation speed in the early stages of learning. However, when the user is familiar with the contents of the extension windows through frequent usage, this maximisation process will no longer be necessary. In fact, after a while the extension windows themselves can be switched off or minimised.

Many modifications may be made in the design and/or construction of a character generation system or an input device for such a system in accordance with the present invention and all such modifications which come within the scope of the invention shall be deemed to be within the ambit of the above description.

1. A character generation system to generate predetermined character representations comprising a plurality of input keys each being associated with at least one unique part character unit, and character generation means receiving key input signals on actuation of a key and adapted to generate a unique character dependent on the combination of actuated keys.

2. A character generation system according to claim 1 wherein each key is associated with at least one radical in addition to the unique part character unit.

3. A character generation system according to claim 2 wherein the radical incorporates the part character unit.

4. A character generation system according to claim 2 wherein different part character units, or radicals, are generated by actuation of the respective keys in combination with actuation of a selected function key.

5. A character generation system according to claim 1, further comprising a display monitor on which a selection of possible radicals, characters or part characters is displayed when a selected key is actuated.

6. A character generation system according to claim 5 wherein an extension window of the display displays a character associated with the actuated key or key combination, when more than one key has been actuated.

7. A character generation system according to claim 5 wherein a displayed radical or character has one or more strokes, which need to be combined with the strokes or radicals generated by the actuated key or key combination to make up the completed character, displayed in a contrasting colour.

8. A character generation system according to wherein displayed characters, radicals or strokes actuated by a key in conjunction with a function key are displayed in a contrasting colour.

9. A character generation system according to claim 1 wherein the characters generated by actuation of the keys are Chinese characters.

10. An input device to generate predetermined graphical indicia representations, such as language characters, comprising a plurality of input keys each having associated therewith at least one unique unit, the units comprising recognizable parts of the graphical indicia, and generation means to generate a predetermined representation for any given key, or key combination, actuation.

11. An input device according to claim 10 wherein each key is associated with at least one radical in addition to the unique unit.

12. An input device according to claim 11 wherein the radical incorporates the unit.

13. An input device according to claim 10 wherein the unit for at least some keys comprises a plurality of strokes.

14. An input device according to claim 10 wherein different units, or radicals, are generated by actuation of the respective keys in combination with actuation of a selected function key.

15. An input device according to claim 10, further comprising a display monitor on which a selection of possible radicals, characters or part characters is displayed when a selected key is actuated.

16. An input device according to claim 15 wherein an extension window of the display displays a character associated with the actuated key or key combination, when more than one key has been actuated.

17. An input device according to claim 15 or claim 16 wherein a displayed radical or character has one or more strokes, which need to be combined with the strokes or radicals generated by the actuated key or key combination to make up the completed character, displayed in a contrasting colour.

18. An input device according to claim 17 wherein displayed characters, radicals or strokes actuated by a key in conjunction with a function key are displayed in a contrasting colour.

19. An input device according to claim 10 wherein the characters generated by actuation of the keys are Chinese characters.

20. An input device according to claim 10 wherein each key actuation or combination of key actuations will generate one unique character.

21. An input device according to claim 10 wherein ten keys are used for generation of a predetermined number of unique graphical indicia representations.

22. An input device according to claim 21 wherein the generated indicia representations comprise language characters.

23. (Canceled)

24. A character generation system according to claim 1 wherein the part character unit for at least some keys comprises a plurality of strokes.
